(19) United States
(12) Patent Application Publication
(10) Pub. No.: US 2012/0084637 A1
(43) Pub. Date: Apr. 5, 2012

(54) IMAGE PROCESSING APPARATUS, IMAGE PROCESSING METHOD, AND STORAGE MEDIUM STORING IMAGE PROCESSING PROGRAM

(75) Inventor: Kana MIZUTANI, Nagoya-shi (JP)

(73) Assignee: BROTHER KOGYO KABUSHIKI KAISHA, Aichi-ken (JP)

(21) Appl. No.: 13/051,158

(22) Filed: Mar. 18, 2011

(30) Foreign Application Priority Data
Sep. 30, 2010 (JP) 2010-220323

(51) Int. Cl. G06F 17/00

(52) U.S. Cl. 715/234

(57) ABSTRACT

An image processing apparatus including: a display portion which displays a web page based on web page data; a specifying section which specifies, as a specific area, an area in the displayed web page; an object obtaining section which obtains an object included in the specified specific area; a relevant-information obtaining section which obtains relevant information associated with the obtained object; a map-image-data obtaining section which obtains map image data for displaying a map image, on the basis of a specific position which is a position on the map image, which indicates a position of the object specified by the obtained relevant information; and an output section which outputs obtained the object, the obtained relevant information, and the map image to be displayed based on the obtained map image data, to the display screen such that a position mark indicating the object is marked on the specific position on the map image.

### CROSS REFERENCE TO RELATED APPLICATION

The present application claims priority from Japanese Patent Application No. 2010-220323, which was filed on Sep. 30, 2010, the disclosure of which is herein incorporated by reference in its entirety.

### BACKGROUND OF THE INVENTION

1. Field of the Invention

The present invention relates to an image processing apparatus, an image processing method, and a storage medium storing an image processing program for creating image data.

2. Description of the Related Art

There is known a technique for extracting image data corresponding to an area selected (clipped) by a user from a web page displayed on a monitor of a personal computer. Further, there is known another technique for rearranging, on a desired layout, a plurality of images respectively corresponding to a plurality of sets of image data extracted from a web page.

### SUMMARY OF THE INVENTION

Where the extracted image data includes area information such as a tourist site, a shop, and the like, a user may want to check a position on a map which corresponds to the area information. In this case, the user has to read the area information of the image data from the web page and check the area information on the map in another web page, causing inconvenience to the user.

This invention has been developed in view of the above-described situations, and it is an object of the present invention to provide an image processing apparatus, an image processing method, and a storage medium storing an image processing program for solving the above-described inconvenience.

The object indicated above may be achieved according to the present invention which provides an image processing apparatus comprising: a display portion configured to display a web page on a display screen on the basis of web page data served from a server; a specifying section configured to specify, as a specific area, an area in the web page displayed on the display screen; an object obtaining section configured to obtain an object included in the specific area specified by the specifying section, the object at least partly constituting the web page; a relevant-information obtaining section configured to obtain relevant information associated with the object obtained by the object obtaining section; a map-image-data obtaining section configured to obtain map image data from a server on the basis of a specific position, wherein the map image data is data for displaying a map image including the specific position and wherein the specific position is a position on the map image, which position indicates a position of the object specified by the relevant information obtained by the relevant-information obtaining section; and an output section configured to output the object obtained by the object obtaining section, the relevant information associated with the object and obtained by the relevant-information obtaining section, and the map image to be displayed on the basis of the map image data obtained by the map-image-data obtaining section, to the display screen such that a position mark indicating the object is marked on the specific position on the map image.

The object indicated above may be achieved according to the present invention which provides an image processing method comprising the steps of: displaying a web page on a display screen on the basis of web page data served from a server; specifying, as a specific area, an area in the web page displayed on the display screen; obtaining an object included in the specified specific area, the object at least partly constituting the web page; obtaining relevant information associated with the obtained object; obtaining map image data from a server on the basis of a specific position, wherein the map image data is data for displaying a map image including the specific position and wherein the specific position is a position on the map image, which position indicates a position of the object specified by the relevant information; and outputting the obtained object, the obtained relevant information associated with the object, and the map image to be displayed on the basis of the map image data associated with the object, to the display screen such that a position mark indicating the object is marked on the specific position on the map image.

The object indicated above may be achieved according to the present invention which provides a storage medium storing an image processing program, the image processing program comprising the steps of: specifying, as a specific area, an area in a web page displayed on a display screen on the basis of web page data served from a server; obtaining an object included in the specified specific area, the object at least partly constituting the web page; obtaining relevant information associated with the obtained object; obtaining map image data from a server on the basis of a specific position, wherein the map image data is data for displaying a map image including the specific position and wherein the specific position is a position on the map image, which position indicates a position of the object specified by the relevant information; and outputting the obtained object, the obtained relevant information associated with the object, and the map image to be displayed on the basis of the map image data associated with the object, to the display screen such that a position mark indicating the object is marked on the specific position on the map image.

### BRIEF DESCRIPTION OF THE DRAWINGS

The objects, features, advantages, and technical and industrial significance of the present invention will be better understood by reading the following detailed description of an embodiment of the invention, when considered in connection with the accompanying drawings, in which:

FIG. 1 is a block diagram showing a configuration of a communication system;

FIG. 2 is a flow-chart showing an operation of a clip application;

FIG. 3 is a flow-chart showing a clip processing performed by the clip application;

FIG. 4 is a flow-chart showing a layout processing performed by the clip application;

FIG. 5 is a flow-chart showing an output-page creating processing performed by the clip application;

FIG. 6 is a view showing an example of a clip information table;

FIG. 7 is a view showing an example of a display setting table;

FIG. 8 is a view showing an example of a display of an image created on the basis of web-page data;

FIG. 9 is a view showing an example of a display of an output-page image;

FIG. 10 is a view showing another example of the display of the output-page image; and

FIG. 11 is a partial-map-image-data obtaining processing performed by the clip application.

### DETAILED DESCRIPTION OF THE EMBODIMENT

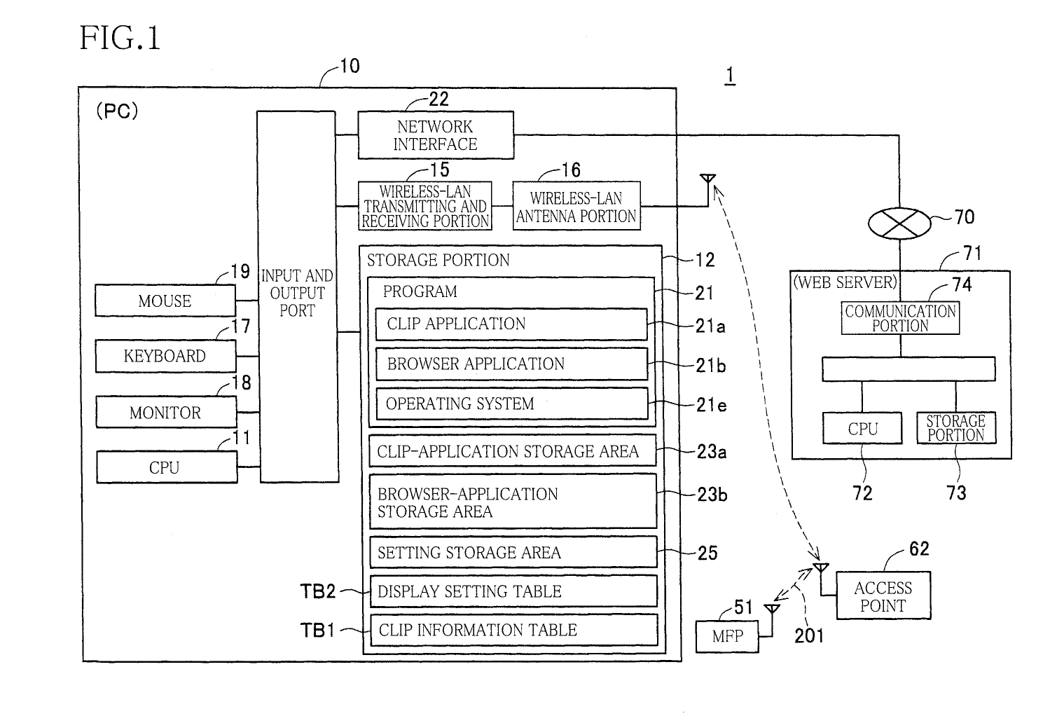

Hereinafter, there will be described an embodiment of the present invention by reference to the drawings. As shown in FIG. 1, a communication system 1 as an embodiment of the present invention includes a personal computer (PC) 10, a multi-function peripheral (MFP) 51, an access point 62, and a web server (deliverer) 71. The MFP 51 has various functions such as a printing function, a scanning function, a copying function, a facsimile function, and the like. The access point 62 is a known networking device.

The PC 10 and the access point 62 are allowed to communicate with each other through a wireless communication using a wireless LAN system. The MFP 51 and the access point 62 are allowed to communicate with each other through the wireless communication using the wireless LAN system. The PC 10 and the web server 71 are connected to each other via an internet 70 so as to be allowed to communicate with each other.

There will be next explained a configuration of the PC 10. The PC 10 mainly includes a CPU 11, a storage portion 12, a wireless-LAN transmitting and receiving portion 15, a wireless-LAN antenna portion 16, a keyboard 17, a monitor 18, a mouse 19, and a network interface 22.

The CPU 11 controls various functions in accordance with programs stored in the storage portion 12 or various signals transmitted and received via the wireless-LAN transmitting and receiving portion 15. It is noted that the storage portion 12 may be configured by combining a Random Access Memory (RAM), a Read Only Memory (ROM), a flash memory, and a hard disc (HDD), for example.

The wireless-LAN transmitting and receiving portion 15 performs a wireless communication via the wireless-LAN antenna portion 16. Digital signals constituting various data are transmitted and received by the wireless-LAN transmitting and receiving portion 15. The network interface 22 performs various communications with the web server 71 via the internet 70. The keyboard 17 includes a plurality of keys for performing the functions of the PC 10. The monitor 18 having a display screen displays thereon various functional information of the PC 10. The mouse 19 is a known device used by a user to operate the PC 10.

The storage portion 12 includes a clip-application storage area 23a as one example of a storage portion, a browser-application storage area 23b, a setting storage area 25, a clip information table TB1, and a display setting table TB2. The clip-application storage area 23a is an area for storing therein various data including clip-image data CI, whole-map image data, partial-map image data, and the like. The browser-application storage area 23b is an area storing therein internet information (i.e., temporary flies) for a browser application 21b as one example of a display portion. Data of a web page is stored in the browser-application storage area 23b as cache data. The setting storage area 25 is an area for storing therein various settings about a specific scale of a map, a layout of an output page, and the like. Here, the scale of the map is a ratio between (a) a distance between two points on a map created by a survey and (b) an actual distance between the two points. Where a size of the map is constant, the smaller the scale, the wider area is displayed. A value of the specific scale may be stored in advance by the user.

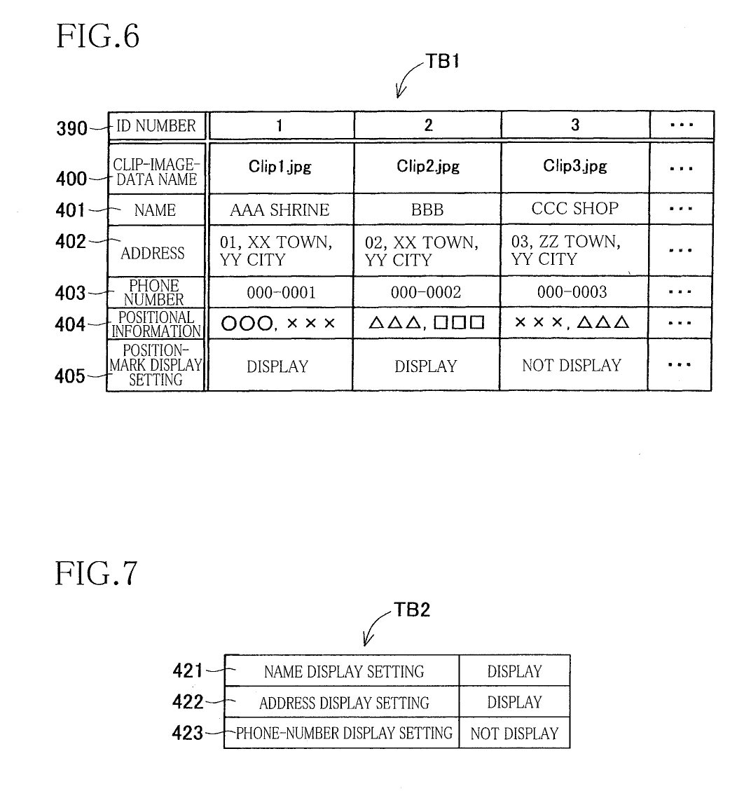

As shown in FIG. 6, the clip information table TB1 stores therein identification (ID) numbers 390, clip-image-data names 400, names 401, addresses 402, phone numbers 403, positional information 404, and position-mark display settings 405. Each of the ID numbers 390 is a number for identifying a corresponding one of a plurality of rows of the clip information table TB1. Each of the clip-image-data names 400 is a name of clip-image data CI corresponding to information stored in the clip information table TB1. Each of the names 401 is a name named in association with display content of corresponding clip-image data CI. Each of the addresses 402 is an address relating to display content of corresponding clip-image data CI. Each of the phone numbers 403 is a phone number relating to display content of corresponding clip-image data CI. The positional information 404 is data about latitude and longitude (latitude and longitude data) corresponding to each address 402. Each of the position-mark display settings 405 is information for determining whether a position mark is to be displayed on a map image or not.

As shown in FIG. 7, the display setting table TB2 stores therein a name display setting 421, an address display setting 422, and a phone-number display setting 423. The name display setting 421 is a setting for determining whether the name 401 is to be displayed on the output page or not. The address display setting 422 is a setting for determining whether the address 402 is to be displayed on the output page or not. The phone-number display setting 423 is a setting for determining whether the phone number 403 is to be displayed on the output page or not.

Further, the storage portion 12 stores therein a program 21. The CPU 11 performs processings in accordance with the program 21 in the storage portion 12. The program 21 includes a clip application 21a, the browser application 21b, and an operating system 21e.

The clip application 21a is an application for performing processings such as a clip processing which will be described below. Further, the clip application 21a is an application corresponding to a part of an extension realized by a plug-in incorporated into the browser application 21b. The clip application 21a is internally started up by the browser application 21b. The browser application 21b is an application for displaying a web page on the monitor 18. The CPU 11 performs the processing in accordance with the browser application 21b. In this processing, HTML (Hyper Text Markup Language) data is downloaded from a web server (e.g., the web server 71), and then reference image data referred to by a data reference tag in the HTML data is downloaded from a reference site, server, or the like. The CPU 11 then stores the downloaded HTML data, the reference image data, and the like into the browser-application storage area 23b. Further, the CPU 11 creates web-page data by using the data such as the HTML data and the reference image data and displays a web page on the monitor 18 on the basis of the created web-page data.

The operating system 21e is a program for providing with a basic function commonly used by the clip application 21a and the browser application 21b. The CPU 11 manages transmission and receipt of the image data and the like between the clip application 21a and the browser application 21b in accordance with the operating system 21e.

Here, a configuration of the web server 71 will be explained. The web server 71 mainly includes a CPU 72, a storage portion 73, and a communication portion 74. The web server 71 is a device providing a client device in a network with web-page data (e.g., the HTML data, the map image data, the reference image data, and the like) and various functions stored in the web server 71. The CPU 72 controls various functions. The storage portion 73 stores therein various HTML data, map databases, and so on. Each map database is a database which can calculate or obtain latitude and longitude from an address. The communication portion 74 transmits and receives various information to and from the PC 10.

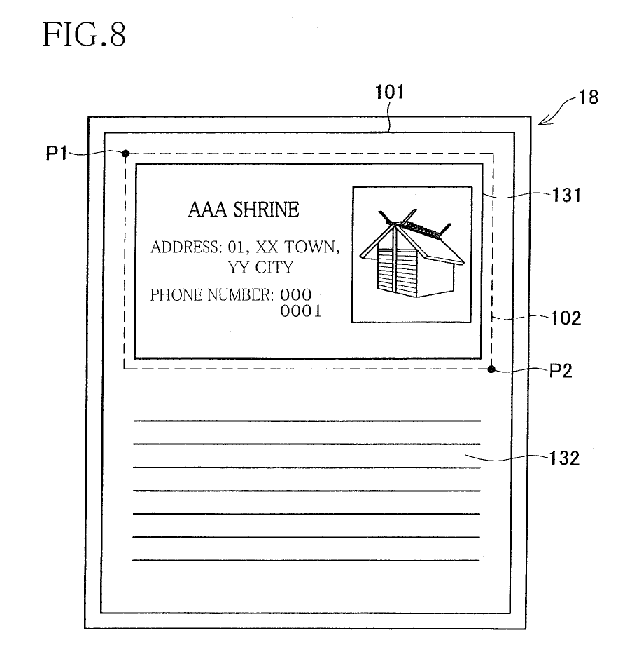

There will be next explained an operation of the communication system 1 as the present embodiment. FIG. 8 shows one example of a web page 101 displayed on the monitor 18. The web page 101 shown in FIG. 8 is a page created on the basis of image data converted from HTML data received by the CPU 11 from the web server 71. In the web page 101 shown in FIG. 8, there are displayed an image object 131 and a string object 132. The image object 131 is displayed on the basis of bitmap image data. The image object 131 includes character strings representing a name, an address, and so on as parts of the image. The string object 132 is displayed in the form of texts on the basis of the HTML data.

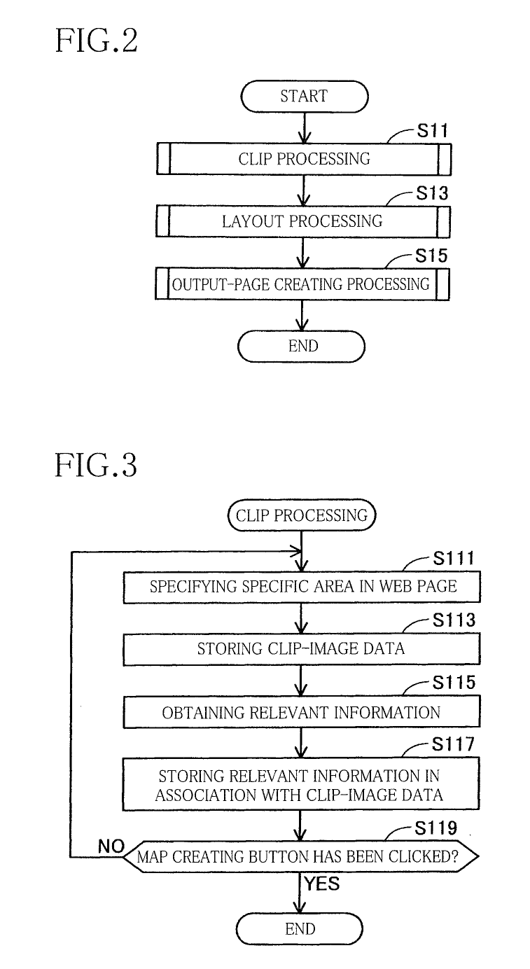

In accordance with the start-up of the clip application 21a, a flow shown in FIG. 2 is started. In this flow, the CPU 11 performs the clip processing in S11, a layout processing in S13, and an output-page creating processing in S15. There will be explained these processings in greater detail below.

<Clip Processing>

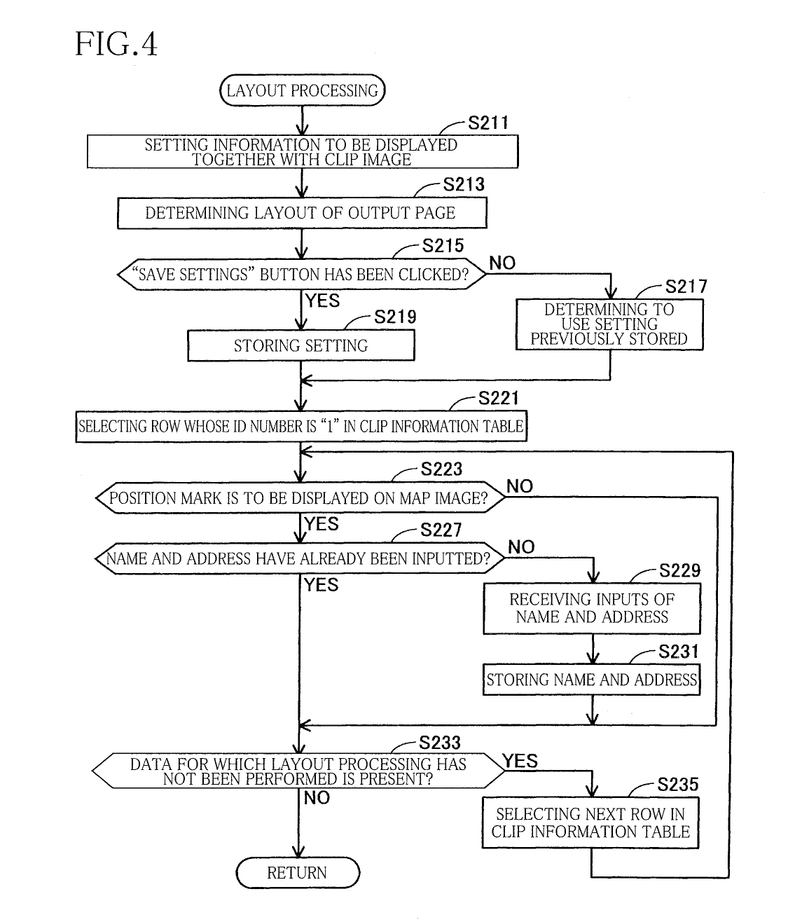

There will be explained the clip processing with reference to FIG. 3. In S111, the CPU 11 specifies a specific area from the web page 101 displayed on the monitor 18, in accordance with an operation of the user. The operation of the user for specifying the specific area is performed with an input device such as the mouse 19. Here, it will be explained how to specify a specific area 102 shown in FIG. 8 as one example. The user moves a cursor to a starting point P1 on the web page 101, then presses a button of the mouse 19, and then moves the cursor toward a lower right side on the monitor 18 while pressing the button of the mouse 19. Then, the user releases the button of the mouse 19 at an endpoint P2. As a result, the specific area 102 is specified.

In S113, the CPU 11 creates clip-image data CI which is image data of a web page specified in the specific area 102. The CPU 11 then gives a clip-image-data name 400 to the clip-image data CI and stores the clip-image data CI into the clip-application storage area 23a. A processing for creating the clip-image data CI is a conventional processing for obtaining image data (bitmap data) based on which the web page 101 is being displayed on the monitor 18. Examples of this processing include (a) a processing in which the CPU 11 obtains image data based on which the web page 101 is being displayed on the monitor 18, in accordance with an API (Application Program Interface) of the operating system 21e (noted that the CPU 11 may obtain image data based on which an entire image is being displayed on the monitor 18, and extract only image data corresponding to the web page 101), and (b) a processing in which the CPU 11 accesses image memory for displaying the image on the monitor 18 and obtains image data for an image in the specific area 102 among image data stored in the image memory. It is noted that the clip-image-data name 400 is a character string which may be given by the clip application or may be given by input of the user with the keyboard 17.

In S115, the CPU 11 obtains relevant information. The relevant information is information stored in association with the clip-image data CI. In the present embodiment, there will be explained a case where the name 401, the address 402, the phone number 403 are obtained as the relevant information. When the relevant information is obtained, the CPU 11 displays an edit box (a quadrangle box-like interface for inputting a character string) on the monitor 18 and then receives input of the user with the keyboard 17 into the edit box. The CPU 11 then obtains the character string inputted into the edit box as the name 401, the address 402, and the phone number 403.

In S117, the CPU 11 stores the relevant information (i.e., the name 401, the address 402, and the phone number 403) into the clip information table TB1 in association with the clip-image data CI obtained in S113. Specifically, the name 401, the address 402, and the phone number 403 are stored into the clip information table TB1 together with the clip-image-data name 400 to establish the association.

In S119, the CPU 11 displays a map creating button on the monitor 18 and judges whether the button has been clicked by the user or not. Where the CPU 11 has judged that the button has not been clicked (S119: NO), the processing returns to S111. On the other hand, where the CPU 11 has judged that the button has been clicked (S119: YES), the processing goes to S13 shown in FIG. 2.

There will be explained a specific example of the clip processing in the present embodiment with reference to FIG. 8. When the specific area 102 has been clipped in S111, the CPU 11 obtains the clip-image data CI of the image object 131. In S113, clip-image data CI corresponding to the image object 131 (i.e., data having an image-data name “Clip1.jpg”) is stored into the clip-application storage area 23a. Then in S115, the CPU 11 receives inputs of a name 401 “AAA shrine”, an address 402 “01, XX town, ZZ city”, and a phone number 403 “000-0001”. Then in S117, the clip-image data CI (whose clip-image-data name 400 is “Clip1.jpg”), the name 401, the address 402, and the phone number 403 are stored into a row whose ID number 390 is “1” in the clip information table TB1 (see FIG. 6). In this operation, the clip-image-data name 400 “Clip1.jpg” is stored, whereby the clip-image data CI, and the name 401, the address 402, and the phone number 403 are associated with each other.

<Layout Processing>

There will be next explained the layout processing performed in S13 (see FIG. 2) with reference to FIG. 4. In S211, the CPU 11 sets information to be displayed together with a clip image to be displayed on the basis of the clip-image data CI, among the relevant information (i.e., the name 401, the address 402, and the phone number 403). Specifically, the CPU 11 sets the name display setting 421, the address display setting 422, and the phone-number display setting 423 in the display setting table TB2 (see FIG. 7) to “DISPLAY” or “NOT DISPLAY”. Further, the position-mark display setting 405 in the display setting table TB2 is set to “DISPLAY” or “NOT DISPLAY”. These settings may be performed by receiving the input of the user via the keyboard 17.

In S213, the CPU 11 determines a layout of an output page created in the output-page creating processing (in S15). In the layout of the output page, the CPU 11 determines an arrangement of the map image, the clip image displayed on the basis of the clip-image data CI, the name 401, the address 402, and the phone number 403. One example of determining the layout includes a method in which several types of layout patterns are created in advance and stored into the setting storage area 25, and the user selects one of these patterns.

In S215, the CPU 11 judges whether the user has clicked a “SAVE SETTINGS” button displayed on the monitor 18 or not. Where the CPU 11 has judged that the user has not clicked the “SAVE SETTINGS” button (S215: NO), this layout processing goes to S217 in which the CPU 11 determines to use settings previously stored (a presence or an absence of the display of the name 401, the address 402, and the phone number 403 and the layout of the output page). On the other hand, where the CPU 11 has judged that the user has clicked the “SAVE SETTINGS” button (S215: YES), this layout processing goes to S219 in which the CPU 11 stores settings that have been set in this time (a presence or an absence of the display of the name 401, the address 402, and the phone number 403 and the layout of the output page) into the setting storage area 25.

In S221, the CPU 11 selects the row whose ID number 390 is “1” (i.e., the row with which the ID number 390 “1” is associated) in the clip information table TB1. In S223, the CPU 11 judges whether a position mark corresponding to the address 402 of the selected row is to be displayed on the map image or not. The position mark is a mark to be displayed on the map image at a position corresponding to a specific position specified by the address 402. This judgment is performed on the basis of whether the position-mark display setting 405 is set to “DISPLAY” or not in the selected row in the clip information table TB1. Where the CPU 11 has judged that the position mark is not to be displayed (S223: NO), this layout processing goes to S233. On the other hand, where the CPU 11 has judged that the position mark is to be displayed (S223: YES), this layout processing goes to S227.

In S227, the CPU 11 judges whether the name 401 and the address 402 have already been inputted in the selected row in the clip information table TB1. Where the CPU 11 has judged that the name 401 and the address 402 have already been inputted (S227: YES), this layout processing goes to S233. On the other hand, where the CPU 11 has judged that the name 401 and the address 402 have not been inputted (S227: NO), this layout processing goes to S229.

In S229, the CPU 11 receives inputs of the name 401 and the address 402. Specifically, the CPU 11 displays the edit box on the monitor 18 and receives the input of the user via the keyboard 17. The CPU 11 then recognizes the character string inputted into the edit box, as the name 401 and the address 402. In S231, the CPU 11 stores the inputted name 401 and address 402 into the clip information table TB1.

Then in S233, the CPU 11 judges whether data for which the layout processing has not been performed is present in the clip information table TB1 or not. This judgment is performed on the basis of whether the data is stored in a row (whose ID number is “n+1”) next to the row (whose ID number is “n”) in which the processing is currently performed, in the clip information table TB1 or not. Where the CPU 11 has judged that the data for which the layout processing has not been performed is present (S233: YES), this layout processing goes to S235. In S235, the CPU 11 selects the next row in the clip information table TB1, and this layout processing returns to S223. On the other hand, where the CPU 11 has judged that the data for which the layout processing has not been performed is not present (S233: NO), this processing goes to S15 (see FIG. 2).

<Output-Page Creating Processing>

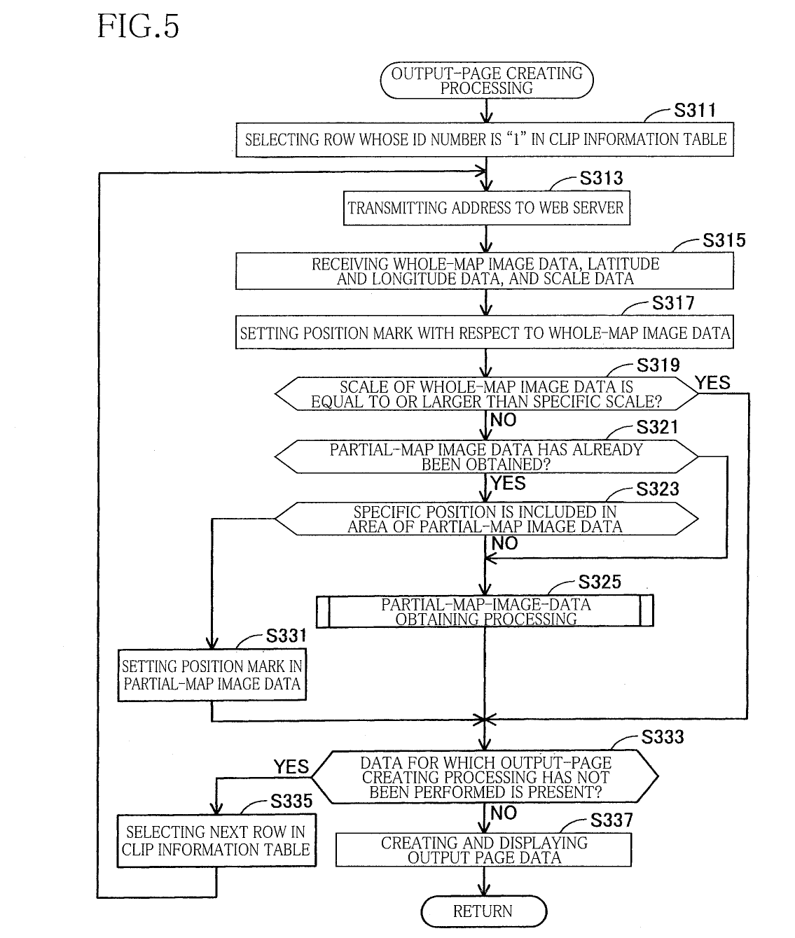

There will be next explained the output-page creating processing performed in S15 (see FIG. 2) with reference to FIG. 5. In S311, the CPU 11 selects the row whose ID number 390 is “1” in the clip information table TB1.

In S313, the CPU 11 transmits an address 402 stored in the currently selected row to the web server 71. The web server 71 obtains latitude and longitude data of a specific position as a position on the map image corresponding to the address 402 on the basis of the map database and transmits the obtained latitude and longitude data to the PC 10. Further, the web server 71 creates whole-map image data containing the specific position and transmits the created whole-map image data to the PC 10. Further, the web server 71 transmits, to the PC 10, scale data representing a scale of the whole-map image data. Here, the whole-map image data is map image data whose scale can be freely adjusted. The number of the obtained whole-map image data is one.

In S315, the CPU 11 receives, from the web server 71, the whole-map image data, and the latitude and longitude data and the scale data of the specific position and stores them into the clip-application storage area 23a. Where the row whose ID number 390 is “1” is being selected in the clip information table TB1, the CPU 11 in S315 receives whole-map image data of an initial setting scale (e.g., 1:5000) which is a scale at which the user can recognize details of a map. This makes it possible to prevent a case where the CPU 11 receives whole-map image data having an unnecessarily small scale even though only a single specific position is to be displayed. It is noted that a map-image scale of “1:5000” is larger than a map-image scale of “1:10000”. In a second or subsequent loop of S313-S335, the CPU 11 in S315 receives whole-map image data having an adjusted scale. This adjustment of the scale is performed such that all specific positions respectively specified by rows from the row whose ID number 390 is “1” to the currently selected row are included in a display area of the currently obtained whole map image (i.e., included in a rectangular frame in which the whole map image is displayed). That is, where one of the rows from the row whose ID number 390 is “1” to the currently selected row has been selected in the clip information table TB1, the CPU 11 receives, from the web server 71, whole-map image data whose display area includes the specific position specified by the address 402 stored in the currently selected row and the specific position(s) each specified by a corresponding one of the addresses 402 respectively stored in the rows before the currently selected row.

In S317, the CPU 11 sets a display position of each position mark with respect to the whole-map image data. Here, one example of a setting method of the display position will be explained. The CPU 11 reads out the position-mark display setting 405 (“DISPLAY” or “NOT DISPLAY”) of the selected row in the clip information table TB1 (see FIG. 6). Where the position-mark display setting 405 is “DISPLAY”, the CPU 11 receives, from the web server 71, latitude and longitude data of a reference point of the whole-map image data (e.g., a left lower or a right upper corner of the map image). The CPU 11 then uses the latitude and longitude data of the specific position to calculate the specific position on the whole-map image data. The CPU 11 then sets the calculated specific position as the display position of the position mark and stores, into the clip-application storage area 23a, the map image data in which the position mark is marked on the map image. It is noted that where the position-mark display setting 405 is “NOT DISPLAY”, the CPU 11 does not perform the setting of the display position of the position mark.

In S319, the CPU 11 judges whether or not a scale of the received whole-map image data is equal to or larger than the specific scale (e.g., 1:100000). This judgment is performed by comparing the scale data received from the web server 71 and the specific scale stored in the setting storage area 25 with each other. Where the CPU 11 has judged that the scale of the whole-map image data is equal to or larger than the specific scale (S319: YES), this output-page creating processing goes to S333. On the other hand, where the CPU 11 has judged that the scale of the whole-map image data is not equal to or larger than the specific scale (S319: NO), this output-page creating processing goes to S321. This is for solving inconvenience that the scale becomes too small for the user viewing the output page to recognize the map image.

In S321, the CPU 11 judges whether the partial-map image data has already been obtained and stored in the clip-application storage area 23a or not. The partial-map image data is map image data having a scale larger than the specific scale (e.g., 1:10000). The number of the obtainment of the partial-map image data is not limited to one. In some case, the CPU 11 obtains two or more sets of the partial-map image data for displaying different areas. Where the CPU 11 has judged in S321 that the partial-map image data has not been obtained (S321: NO), this output-page creating processing goes to S325 in which the CPU 11 performs first obtainment of the partial-map image data. It is noted that, in this first obtainment of the partial-map image data, the partial-map image data is obtained for all the rows of the clip information table TB1 in each of which the ID number 390 is smaller than that selected at a start of the obtainment. As a result, the CPU 11 can obtain the partial-map image data for all the rows of the clip information table TB1. On the other hand, where the CPU 11 has judged in S321 that the partial-map image data has already been obtained the partial-map image data (S321: YES), this output-page creating processing goes to S323.

In S323, the CPU 11 judges whether the specific position specified by the address 402 stored in the currently selected row in the clip information table TB1 is included in an area of the obtained partial-map image data or not. Where the CPU 11 has judged that the specific position is not included in the area (S323: NO), this output-page creating processing goes to S325.

In S325, the CPU 11 performs a partial-map-image-data obtaining processing. Here, there will be explained the partial-map-image-data obtaining processing with reference to FIG. 11. In S411, the CPU 11 transmits the address 402 to the web server 71. The web server 71 obtains the latitude and longitude data of the specific position as a position on the map image corresponding to the address 402 on the basis of the map database and transmits the obtained latitude and longitude data to the PC 10. Further, the CPU 11 creates partial-map image data such that the specific position is positioned at a center of a partial map image to be displayed on the basis of partial-map image data, and transmits the created partial-map image data to the PC 10. Further, the CPU 11 transmits scale data representing a scale of the partial-map image data to the PC 10. The partial-map image data transmitted in this operation has an initial setting scale (e.g., 1:5000). In S413, the CPU 11 receives the partial-map image data, and the latitude and longitude data and the scale data of the specific position from the web server 71 and stores them into the clip-application storage area 23a.

In S415, the CPU 11 judges whether the scale of the partial-map image data received in S413 or S421 which will be described below is appropriate or not. This judgment is performed on the basis of whether, where the scale is decreased to such a scale that a landmark facility or facilities such as a station, a river, and a main road are displayed on the partial map image, the decreased scale is larger than the specific scale (e.g., 1:10000) or not. That is, where the landmark facility is being displayed on the partial map image, and the scale of the partial-map image data is larger than the specific scale, the CPU 11 makes an affirmative decision in S415. The judgment of whether the landmark facility is being displayed on the partial map image or not is performed on the basis of whether or not information about the landmark facility or facilities (e.g., character strings or marks of “XX station”, “XX avenue”, and “XX river”) is included in the partial-map image data received from the web server 71.

Where the CPU 11 has judged that the scale of the partial-map image data is appropriate (S415: YES), this partial-map-image-data obtaining processing goes to S417 in which the CPU 11 determines to use the partial-map image data. Then, this partial-map-image-data obtaining processing goes to S423 in which the CPU 11 sets the display position of the position mark at a center of the partial map image to be displayed on the basis of the partial-map image data. For example, this setting of the display position of the position mark is performed by receiving latitude and longitude data of a reference point of the partial-map image data and setting the display position of the position mark on the basis of the received latitude and longitude data as in the above-described setting of the display position of the position mark for the whole-map image data. After S423, this processing goes to S333 (see FIG. 5).

On the other hand, where the CPU 11 has judged that the scale of the partial-map image data is not appropriate (S415: NO), this partial-map-image-data obtaining processing goes to S416. In S416, the CPU 11 judges whether the scale of the partial-map image data is larger than the specific scale (e.g., 1:10000) or not. Where the CPU 11 has judged that the scale of the partial-map image data is larger than the specific scale (S416: YES), this partial-map-image-data obtaining processing goes to S419. In S419, the CPU 11 requests the web server 71 to transmit partial-map image data of a one-size smaller scale than the current scale. Then in S421, the CPU 11 receives again the partial-map image data, and the latitude and longitude data and the scale data of the specific position from the web server 71, and this partial-map-image-data obtaining processing returns to S415. Where the CPU 11 has judged that the scale of the partial-map image data is not larger than the specific scale (S416: NO), the CPU 11 gives up to display the landmark facility in the display area of the partial map image, and this partial-map-image-data obtaining processing goes to S417 in which the CPU 11 determines to use the partial-map image data.

Returning to the explanation in FIG. 5, where the CPU 11 judges in S323 that the specific position specified by the address 402 stored in the currently selected row is included in the area of the obtained partial-map image data (S323: YES), this output-page creating processing goes to S331. In S331, the CPU 11 sets the display position of the position mark in the obtained partial-map image data.

In S333, the CPU 11 judges whether data for which the output-page creating processing has not been performed is present in the clip information table TB1 or not. Where the CPU 11 has judged that such data is present (S333: YES), this output-page creating processing goes to S335. In S335, the CPU 11 selects a next row in the clip information table TB1, and this output-page creating processing returns to S313. On the other hand, where the CPU 11 has judged that such data is not present (S333: NO), this output-page creating processing goes to S337.

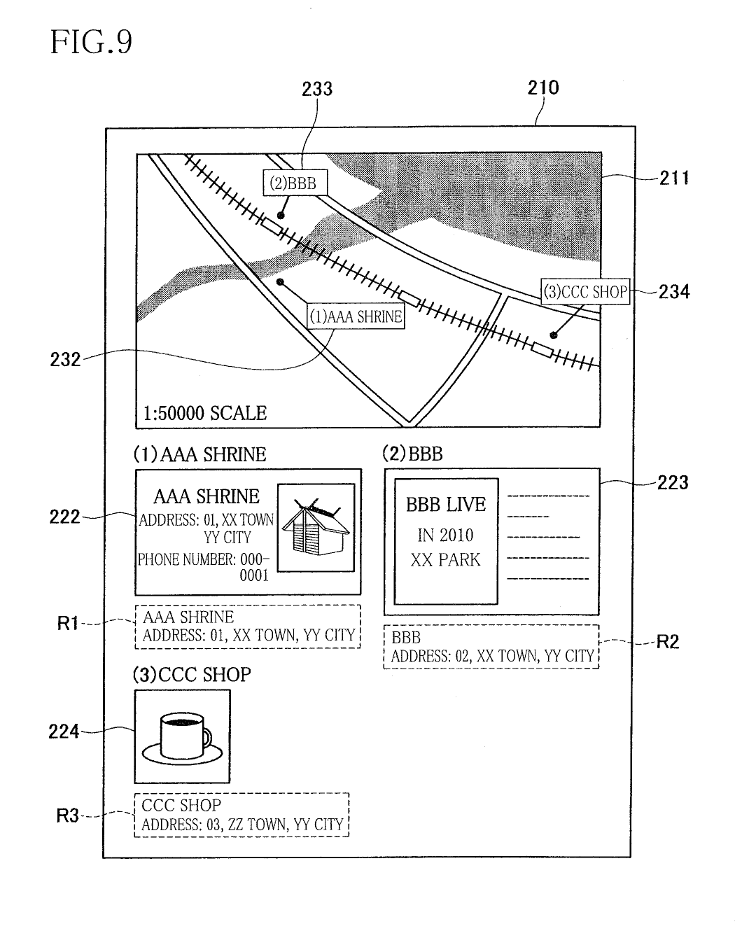

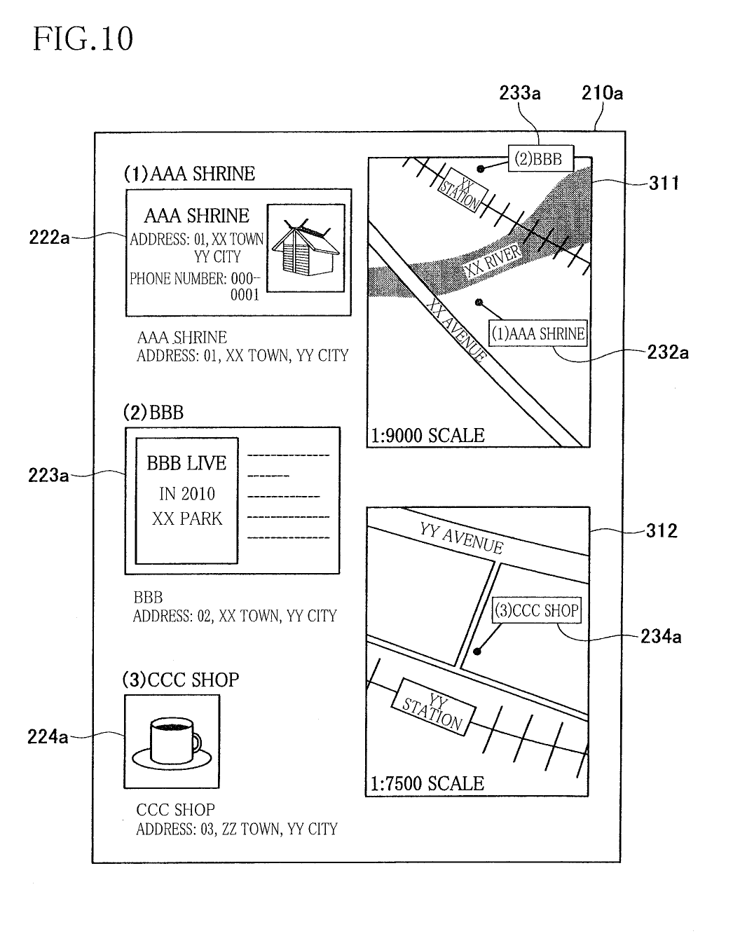

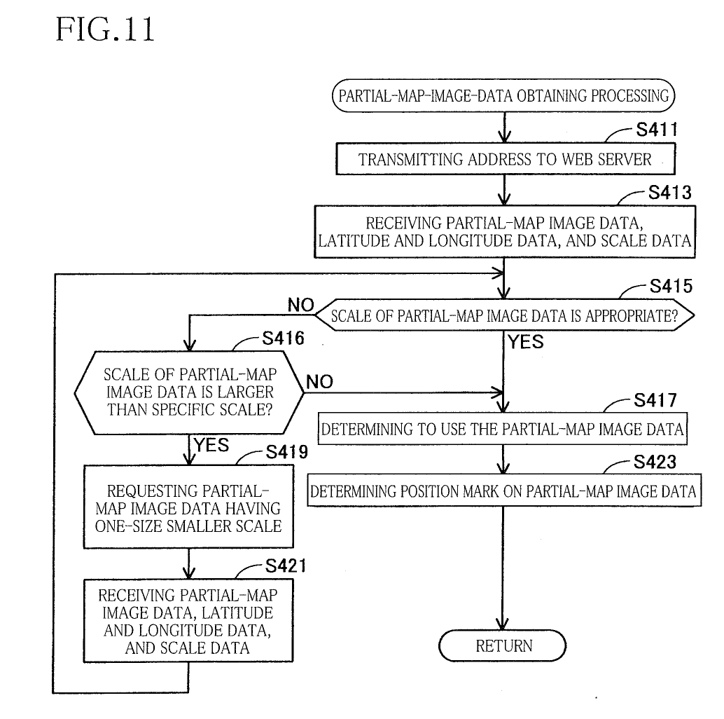

In S337, the CPU 11 combines the whole-map image data, the partial-map image data, the clip-image data CI, the name 401, the address 402, and the phone number 403 according to the layout determined in the layout processing (S13). As a result, data of the output page (output page data) has been created. Further, the CPU 11 displays an output page on the monitor 18 on the basis of the output page data. It is noted that, where the CPU 11 has judged that the scale of the whole-map image data is equal to or larger than the specific scale in a state in which the specific positions respectively corresponding to all the addresses 402 stored in the clip information table TB1 are displayed on the whole map image (S319: YES), no partial image is included in the output page displayed in S337. It is noted that, as shown in FIGS. 9 and 10, in a whole map image 211 and partial-map images 311, 312, the CPU 11 draws a straight line between each of names 401 of respective clip images 222, 223, 224 and a corresponding one of position marks 232-234 and 232a-234a.

There will be next explained a specific example of the output-page creating processing with reference to FIGS. 9 and 10. As one example, there will be explained a case where data is stored in rows whose ID numbers 390 are “1”, “2”, and “3” as shown in the clip information table TB1 in FIG. 6. In this example, the specific scale is set to “1:10000”. Further in this example, where three specific positions specified by data whose ID numbers 390 are “1”, “2”, and “3” are to be displayed on a whole map image, a scale of the whole map image becomes smaller than the specific scale (S319: NO). Further in this example, the two specific positions specified by the data whose ID numbers 390 are “1” and “2” are included in the area of the same partial-map image data (S323: YES). Further in this example, as shown in the display setting table TB2 in FIG. 7, each of the name display setting 421 and the address display setting 422 is “DISPLAY”, and the phone-number display setting 423 is “NOT DISPLAY”. Thus, an output-page image 210 (see FIG. 9) including the whole map image 211 and an output-page image (see FIG. 10) including the partial-map images 311, 312 are displayed on the monitor 18.

The clip images 222, 223, 224 are displayed on the output-page image 210 shown in FIG. 9. The clip image 222 is an image corresponding to image data whose clip-image-data name 400 is “Clip1.jpg”, which image data is stored in the row whose ID number 390 is “1” in the clip information table TB1 (see FIG. 6). Further, the name 401 and the address 402 corresponding to the clip image 222 are displayed on an area R1 adjacent to the clip image 222. It is noted that the phone number 403 is not displayed according to the setting in the display setting table TB2 (see FIG. 7) in this example. Further, the position mark 232 corresponding to the clip image 222 is displayed on the whole map image 211. The clip image 222 and the position mark 232 are associated with each other by being given the same symbol “(1)”.

Likewise, the clip image 223 is an image corresponding to image data whose clip-image-data name 400 is “Clip2.jpg”, which image data is stored in the row whose ID number 390 is “2” in the clip information table TB1. Further, the name 401 and the address 402 corresponding to the clip image 223 are displayed on an area R2 adjacent to the clip image 223. Further, the position mark 233 corresponding to the clip image 223 is displayed on the whole map image 211. The clip image 223 and the position mark 233 are associated with each other by being given the same symbol “(2)”.

Likewise, the clip image 224 is an image corresponding to image data whose clip-image-data name 400 is “Clip3.jpg”, which image data is stored in the row whose ID number 390 is “3” in the clip information table TB1. Further, the name 401 and the address 402 corresponding to the clip image 224 is displayed on an area R3 adjacent to the clip image 224. Further, the position mark 234 corresponding to the clip image 224 is displayed on the whole map image 211. The clip image 224 and the position mark 234 are associated with each other by being given the same symbol “(3)”.

In an output-page image 210a shown in FIG. 10, each of a scale of the partial-map image 311 (1:9000) and a scale of the partial-map image 312 (1:7500) is larger than the specific scale (1:10000). The position mark 232a corresponding to a clip image 222a is displayed on a central area of the partial-map image 311. Further, the position mark 233a corresponding to a clip image 223a is also displayed on the partial-map image 311. Further, landmark facilities such as an “XX station” and an “XX river” are displayed on the partial-map image 311. The position mark 234a corresponding to a clip image 224a is displayed on a central area of the partial-map image 312. Further, landmark facilities such as a “YY station” and a “YY avenue” are displayed on the partial-map image 312.

<Effects of Embodiment>

In this clip application 21a in the present embodiment, the clip-image data CI of the specific area 102 selected by the user and the relevant information (e.g., the name 401 and the address 402) associated with the clip-image data CI can be stored into the storage portion 12. Further, the position mark can be displayed at the position corresponding to the address 402 on the map image in the output-page creating processing. Accordingly, the user does not need to read and obtain information (such as an address) from the web page and then check the information on the map, thereby increasing convenience of the user.

Further, in this clip application 21a, the scale of the partial map image is always larger than the specific scale, making it possible to prevent a case where the scale becomes too small for the user to view the map image. Further, in this clip application 21a, where the plurality of the specific positions can be displayed in a single partial map image, these specific positions can be displayed on the single partial map image. Accordingly, it is possible to reduce the number of the partial-map image data to be obtained, thereby decreasing a space required for the display of the partial-map image data.

Further, in this clip application 21a, all the specific positions can be displayed on the whole map image. Accordingly, the user can easily recognize positional relationships among all the specific positions, thereby enhancing the convenience of the user.

While the embodiment of the present invention has been described above, it is to be understood that the invention is not limited to the details of the illustrated embodiment, but may be embodied with various changes and modifications, which may occur to those skilled in the art, without departing from the spirit and scope of the invention.

<Modification of Embodiment>

For example, the relevant information obtained in S115 is not limited to the name 401, the address 402, and the phone number 403. That is, the relevant information may be any information as long as the information relates to the clip-image data CI created in S113. Examples of the information include a mail address, various notes, business hours, a link address (URL), and the like.

Further, the relevant information obtained in S115 does not necessarily include the name 401, the address 402, and the phone number 403. Obtainment of at least the address 402 can achieve the effects of this clip application 21a.

In S115, a manner for obtaining various information is not limited to receiving the inputting of the user. For example, the CPU 11 may analyze the clip-image data CI and extract character-string data to obtain various information. Specifically, where the clip-image data CI is in the form of bitmap image data, an OCR (Optical Character Reader) processing is performed to identify character strings in the clip-image data CI on the basis of shapes of characters. The identified character strings are then converted into the character-string data usable on a computer. Where the clip-image data CI is in the form of HTML image data, the CPU 11 analyzes the HTML data to extract the character-string data. When obtaining address data, the CPU 11 searches, in the character-string data, key words (such as a city, a town, and the like) relating to the address. Where the CPU 11 has detected the keyword(s), the CPU 11 obtains the character-string data including this keyword as the address data. As a result, the input of the relevant information by the user can be omitted, thereby enhancing the convenience of the user.

In the above-described embodiment, the map image data and the map database are stored in the storage portion 73 of the web server 71, but the present invention is not limited to this configuration. Also in a case where the map image data and the map database are stored in the storage portion 12 of the PC 10, it is possible to achieve the effects of this clip application 21a.

Various manners may be employed for a manner in which the latitude and longitude data of the specific position is received from the web server 71 in S315. For example, the latitude and longitude data may be received in a state in which information of a map to be obtained such as latitude, longitude, a scale, and the like is included in a part of a URL (Uniform Resource Locator).

In the above-described embodiment, the clip application 21a is incorporated into the browser application 21b as the plug-in, but the browser application 21b may have the functions of the clip application 21a.

In the above-described embodiment, the clip application 21a is used in the PC 10, the present invention is not limited to this configuration. The clip application 21a is also usable in various devices such as a mobile phone and a multi-function peripheral.

Specifying the specific area 102 is not limited to using the input device such as the mouse 19. For example, the monitor 18 may have a touch panel, and the user may specify the specific area 102 with an input object such as his or her finger, a pen, or the like. Further, the shape of the specific area 102 is not limited to the rectangular shape. For example, the shape of the specific area 102 may be a parallelogram or a circle.

Further, the scales described in the above-described embodiment are merely examples, and other scales may be used. Further, a display manner of the scale is not limited to a manner such as “1:10000”, and various manners may be used. For example, a specific scale image (with tick marks) is displayed on the map image in one km increments. It is noted that, where this display method is used, decrease in the scale means increase in the number indicating a distance in one tick. For example, where the scale of the map whose one tick is 1 km is gradually decreased, one tick is increased to 2, 3, . . . (km).

Further, various methods may be used as a method for obtaining the partial-map image data. For example, partial-map image data may be obtained for each of all the addresses 402 stored in the clip information table TB1. In this case, where five sets of the clip-image data CI are stored in the clip-application storage area 23a, for example, five sets of the partial-map image data respectively corresponding to the five sets of the clip-image data CI may be obtained and displayed on the output page.

Further, the number of the relevant information stored in association with one set of clip-image data CI in S115 (see FIG. 3) is not limited to one. For example, a plurality of sets of the relevant information can be associated with one set of the clip-image data CI. In this case, only a single clip image is displayed on the output page (in S337), but a plurality of position marks relating to the clip image are displayed on the whole map image. Further, also in a case where the partial map image is displayed, only one clip image is displayed, but a plurality of partial map images relating to the clip image are displayed in the output page.

Further, the judgment in S415 as to whether the scale of the partial-map image data is appropriate or not may be performed by the web server 71. In this case, the web server 71 receives the specific scale from the PC 10 and stores the specific scale into the server 71, for example.

Various scales may be used as the scale of the partial-map image data determined in S417. For example, the CPU 11 has judged in S416 that the scale of the partial-map image data is not larger than the specific scale, e.g., 1:10000 (S416: NO), the CPU 11 determines to use partial-map image data having an initial setting scale (e.g., 1:5000), which partial-map image data has been obtained in S413. As a result, where the landmark facilities cannot be displayed in the display area of the partial map image, a partial map image having a scale larger than the specific scale can be displayed on the output page.

The technological components described in the present specification or the drawings exhibit technological utility individually or in various combinations, and are not limited to the combinations disclosed in the claims at the time of application. Furthermore, the technology illustrated in the present specification or the drawings may simultaneously achieve a plurality of objects, and has technological utility by achieving one of these objects.

In view of the above, the CPU 11 can be considered to include a specifying section configured to specify an area in the web page 101 as the specific area 102, and this specifying section can be considered to perform the processing in S111. Further, the CPU 11 can be considered to include an object obtaining section configured to obtain the object included in the specific area 102, and this object obtaining section can be considered to perform the processing in S113. Further, the CPU 11 can be considered to include a relevant-information obtaining section configured to obtain the relevant information associated with the object, and this relevant-information obtaining section can be considered to perform the processing in S115. Further, the CPU 11 can be considered to include a map-image-data obtaining section configured to obtain the map image data on the basis of the specific position, and this map-image-data obtaining section can be considered to perform the processing in S315 and S325. Further, the CPU 11 can be considered to include an output section configured to output the object, the relevant information, and the map image to be displayed on the basis of the map image data, to the monitor 18 such that the position mark is marked on the specific position, and this output section can be considered to perform the processing in S337.

Further, the CPU 11 can be considered to include a scale judging section configured to judge whether the scale of the map image to be displayed on the basis of the map image data is larger than the specific scale or not, and this scale judging section can be considered to perform the processing in S319. Further, the CPU 11 can be considered to include a selecting section configured to select the plurality of the specific positions one by one, and this selecting section can be considered to perform the processing in S335. Further, the CPU 11 can be considered to include an inclusion judging section configured to judge whether the specific position selected by the selecting section is included in a display area of a map image of one of at least one set of the map image data stored in the clip-application storage area 23a, and this inclusion judging section can be considered to perform the processing in S323.

What is claimed is:

1. An image processing apparatus comprising:
a display portion configured to display a web page on a display screen on the basis of web page data served from a server;
a specifying section configured to specify, as a specific area, an area in the web page displayed on the display screen;
an object obtaining section configured to obtain an object included in the specific area specified by the specifying section, the object at least partly constituting the web page;
a relevant-information obtaining section configured to obtain relevant information associated with the object obtained by the object obtaining section;
a map-image-data obtaining section configured to obtain map image data from a server on the basis of a specific position, wherein the map image data is data for displaying a map image including the specific position and wherein the specific position is a position on the map image, which position indicates a position of the object specified by the relevant information obtained by the relevant-information obtaining section; and
an output section configured to output the object obtained by the object obtaining section, the relevant information associated with the object and obtained by the relevant-information obtaining section, and the map image to be displayed on the basis of the map image data obtained by the map-image-data obtaining section, to the display screen such that a position mark indicating the object is marked on the specific position on the map image.

2. The image processing apparatus according to claim 1, further comprising a storage portion storing the object obtained by the object obtaining section and the relevant information obtained by the relevant-information obtaining section in association with each other.

3. The image processing apparatus according to claim 2,
wherein the map-image-data obtaining section is configured to obtain at least two sets of map image data where there are a plurality of the specific positions, and
wherein the map-image-data obtaining section is configured to obtain the at least two sets of map image data such that at least one of the plurality of the specific positions is included in a display area of each of map images respectively based on the at least two sets of map image data.

4. The image processing apparatus according to claim 3, further comprising a scale judging section configured to judge whether a scale of the map image to be displayed on the basis of the map image data is larger than a specific scale or not,
wherein, where the scale judging section has not judged that a scale of a map image whose display area includes the plurality of the specific positions is larger than the specific scale, the map-image-data obtaining section newly obtains map image data such that at least one of the plurality of the specific positions is included in a display area of each of map images based on the map image data newly obtained and the at least two sets of map image data.

5. The image processing apparatus according to claim 3,
wherein the storage portion is configured to stores the map image data obtained by the map-image-data obtaining section in association with the object obtained by the object obtaining section,
wherein the image processing apparatus further comprises:
a selecting section configured to select the plurality of the specific positions one by one; and
an inclusion judging section configured to judge whether the specific position selected by the selecting section is included in a display area of a map image of one of at least one set of the map image data stored in the storage portion, and
wherein the map-image-data obtaining section is configured to newly obtain map image data for displaying a map image whose display area includes the specific position, on condition that the inclusion judging section has judged that the specific position is not included in the display area of the map image of one of the at least one set of the map image data.

6. The image processing apparatus according to claim 1, wherein, where there are a plurality of the specific positions, the map-image-data obtaining section obtains one set of the map image data whose map-image scale has been adjusted such that the plurality of the specific positions are included in a display area of a map image based on the one set of the map image data.

7. The image processing apparatus according to claim 3, further comprising a scale judging section configured to judge whether a scale of the map image to be displayed on the basis of the map image data is larger than a specific scale or not,
wherein, where the scale judging section has judged that a scale of a map image whose display area includes all the plurality of the specific positions is larger than the specific scale, the map-image-data obtaining section does not newly obtain map image data.

8. The image processing apparatus according to claim 1, wherein the relevant-information obtaining section is configured to identify a character string included in the object obtained by the object obtaining section and to obtain the identified character string as the relevant information.

9. The image processing apparatus according to claim 1, further comprising an input receive section configured to receive an input of the relevant information by a user,
wherein the relevant-information obtaining section is configured to obtain, as the relevant information, the input received by the input receive section.

10. The image processing apparatus according to claim 1, wherein the output section is configured to display the position mark and the object obtained by the object obtaining section in association with each other.

11. An image processing method comprising the steps of:
displaying a web page on a display screen on the basis of web page data served from a server;
specifying, as a specific area, an area in the web page displayed on the display screen;
obtaining an object included in the specified specific area, the object at least partly constituting the web page;
obtaining relevant information associated with the obtained object;
obtaining map image data from a server on the basis of a specific position, wherein the map image data is data for displaying a map image including the specific position and wherein the specific position is a position on the map image, which position indicates a position of the object specified by the relevant information; and
outputting the obtained object, the obtained relevant information associated with the object, and the map image to be displayed on the basis of the map image data associated with the object, to the display screen such that a position mark indicating the object is marked on the specific position on the map image.

12. A storage medium storing an image processing program, the image processing program comprising the steps of:
specifying, as a specific area, an area in a web page displayed on a display screen on the basis of web page data served from a server;
obtaining an object included in the specified specific area, the object at least partly constituting the web page;
obtaining relevant information associated with the obtained object;
obtaining map image data from a server on the basis of a specific position, wherein the map image data is data for displaying a map image including the specific position and wherein the specific position is a position on the map image, which position indicates a position of the object specified by the relevant information; and
outputting the obtained object, the obtained relevant information associated with the object, and the map image to be displayed on the basis of the map image data associated with the object, to the display screen such that a position mark indicating the object is marked on the specific position on the map image.

13. The storage medium according to claim 12, further comprising a step of storing the obtained object and the obtained relevant information in association with each other.

14. The storage medium according to claim 13,
wherein, in the step of obtaining the map image data, at least two sets of map image data are obtained where there are a plurality of the specific positions, and
wherein, in the step of obtaining the map image data, the at least two sets of map image data are obtained such that at least one of the plurality of the specific positions is included in a display area of each of map images respectively based on the at least two sets of map image data.

15. The storage medium according to claim 14, further comprising a step of judging whether a scale of the map image to be displayed on the basis of the map image data is larger than a specific scale or not,
wherein, where it has not been judged that a scale of a map image whose display area includes the plurality of the specific positions is larger than the specific scale, map image data is obtained in the step of obtaining the map image data, such that at least one of the plurality of the specific positions is included in a display area of each of map images based on the map image data newly obtained and the at least two sets of map image data.

16. The storage medium according to claim 14,
wherein, in the step of storing the obtained object and the obtained relevant information, the obtained map image data is stored in association with the obtained object,
wherein the storage medium further comprises the steps of:
selecting the plurality of the specific positions one by one; and
judging whether the selected specific position is included in a display area of a map image of one of at least one set of the stored map image data, and
wherein, in the step of obtaining the map image data, map image data for displaying a map image whose display area includes the specific position is newly obtained on condition that it has been judged that the specific position is not included in the display area of the map image of one of the at least one set of the map image data.

17. The storage medium according to claim 12, wherein, where there are a plurality of the specific positions, one set of the map image data whose map-image scale has been adjusted such that the plurality of the specific positions are included in a display area of a map image based on the one set of the map image data is obtained in the step of obtaining the map image data.

18. The storage medium according to claim 14, further comprising a step of judging whether a scale of the map image to be displayed on the basis of the map image data is larger than a specific scale or not,
wherein, where it has been judged that a scale of a map image whose display area includes all the plurality of the specific positions is larger than the specific scale, map image data is not newly obtained in the step of obtaining the map image data.

19. The storage medium according to claim 12, further comprising a step of receiving an input of the relevant information by a user,
wherein the received input is obtained as the relevant information in the step of obtaining the relevant information.

20. The storage medium according to claim 12, wherein the position mark and the obtained object are displayed in association with each other in the output step.
